(19) United States
(12) Patent Application Publication
(10) Pub. No.: US 2022/0000125 A1
(43) Pub. Date: Jan. 6, 2022

(54) BREAD MANUFACTURE

(71) Applicant: SIGNATURE FLATBREADS (UK) LIMITED, Dunstable, Bedfordshire (GB)

(72) Inventor: William EID, Bedfordshire (GB)

(21) Appl. No.: 17/296,594

(22) PCT Filed: Nov. 29, 2019
(86) PCT No.: PCT/GB2019/053393

§ 371 Date: May 25, 2021

(30) Foreign Application Priority Data
Nov. 30, 2018 (GB) 1819529.7

(51) Int. Cl. A21C 11/10; A21C 3/02; A21C 5/00; A21C 9/08; A21C 13/00; A21D 8/10; A21D 13/32; A21D 13/43; B26F 3/00

(52) U.S. Cl. CPC A21C 11/10; A21C 3/02; A21C 5/00; A21C 9/08; B26F 3/004; A21D 8/10; A21D 13/32; A21D 13/43; A21C 13/00

(57) ABSTRACT

A method of manufacture of a bread, the bread comprising a pocket and having at least one open edge, the method comprising: preparing a dough; working the dough into a sheet including dusting a surface of the sheet of dough with additional flour; proofing the sheet of dough in a proofing room having a pre-determined humidity level, such that a moisture content of the additional surface flour is increased; cutting the proofed sheet of dough into a plurality of substantially tessellating shaped portions; baking each portion to form a bread, such that steam is generated during baking and forms a pocket in the bread; and cutting each bread into at least two parts, each part forming a pocket bread having at least one open edge, the open edge providing access to the pocket, wherein a secondary opening process is not required to provide access to the pocket.

### TECHNICAL FIELD

The present disclosure relates to a method of manufacture of a bread comprising a pocket, an apparatus for cutting a bread, and an improved pocket bread.

### BACKGROUND

It is known to provide bread having a pocket in it, for example a Pita bread or a soft taco shell. Often a soft dough is desirable for these types of bread. With regard to Pita in particular, there are known methods for manufacturing the bread on a large scale.

One such method is the sheet and cut method, where dough is formed into a sheet and cut into oval Pita shaped pieces before being baked. This method involves a significant amount of dough which requires re-work. Furthermore to form the dough into a sheet it must be dusted with flour, which when baked forms a barrier around the bread giving the baked bread a dull colour.

Another method is the ball method, wherein a ball of dough is formed and then rolled into oval or round shapes. This method results in little re-worked dough, however the baked breads are inconsistent in size and shape and the dough balls require significant separation to ensure space to be rolled without overlapping. This method can avoid the requirement of flour dusting, however to do so the dough must have a lower water content than usual and therefore it is difficult to create a soft dough.

### SUMMARY OF THE INVENTION

The present invention attempts to overcome or alleviate the problems described above by providing an improved method of manufacture of a pocket bread, an apparatus for cutting a bread such as a pocket bread and an improved pocket bread.

According to a first aspect of the invention there is provided, a method of manufacture of a bread, the bread comprising a pocket and having at least one open edge, the method comprising: preparing a dough comprising flour and water; working the dough into a sheet including dusting a surface of the sheet of dough with additional flour; proofing the sheet of dough in a proofing room having a pre-determined humidity level, such that a moisture content of the additional surface flour is increased; cutting the proofed sheet of dough into a plurality of substantially tessellating shaped portions; baking each portion to form a bread, such that steam is generated during baking and forms a pocket in the bread, each bread shrinking away from an adjacent bread during baking, such that the separation distance between each bread is increased; and cutting each bread into at least two parts, each part forming a pocket bread having at least one open edge, the open edge providing access to the pocket, wherein a secondary opening process is not required to provide access to the pocket.

This method minimises the amount of re-worked dough which can become tougher than the preferred soft dough. It also maximises efficiency of the dough usage. A large separation distance between breads can be inefficient and costly as less bread can be baked in a specific time period. However, if the separation distance is too small the edges of the breads will not bake evenly. The shrinking of the bread portion enables an even bake on all edges. A dull bake can also be off-putting for a consumer who would expect bread baked with a golden brown colour. If the additional flour remains on the surface of the dough without the moisture content of the additional flour being increased, then it can result in a dull bake.

Each bread can be cut into at least two parts by a water jet cutter.

Water jet cutting the bread can be advantageous over alternative methods as it provides a clean cut without welding the edges of the bread together, which can occur when using a guillotine to make the cut, or without damaging the edges of the bread, such as when a band saw is used to make the cut. Cutting the bread into two parts provides a pocket bread with an opening, therefore a secondary process to open the pocket bread is not required. Water jet cutting therefore allows soft or very soft bread to be cut which other methods, if used, would damage the bread.

The sheet of dough can comprise a first side and a second side, the first side disposed opposite to the second side, wherein both the first side and second side are dusted with additional surface flour. This can be achieved wherein the sheet of dough is conveyed along a first belt where additional surface flour is added to the first side, the sheet of dough is then inverted onto a second belt where additional surface flour is added to the second side.

The end of the first belt, at the interface between the first belt and the second belt, can be angled in respect to a direction of movement of the sheet of dough to assist in inverting the sheet of dough as it is conveyed from the first belt to the second belt. The sheet of dough can be conveyed as a continuous sheet.

The pre-determined humidity level, such that a moisture content of the additional surface flour is increased, can be a relative humidity between 60% and 80%, and typically about 70%.

The tessellating shaped portions can be polygonal in shape, preferably they can be quadrilateral in shape and more preferably they can be rectangular. However alternative shapes can be envisaged. The tessellating shaped portions may comprise at least one rounded corner.

Tessellating shaped portions allow for minimal leftover or re-worked dough and in some instances no leftover or re-work. This is due to the majority or the entire sheet of dough being formed into portions of dough.

A first cut line can be made across a first orientation of the bread, and a second cut line can be made across a second orientation of the bread, the first cut line of the bread being substantially perpendicular to the second cut line such that four pocket breads each having two open edges are formed from the bread portion.

Two open sides provide a quicker, easier and more efficient means to fill the pocket bread with foodstuffs. Having one large portion which is cut into four pocket breads with two open edges each, enables a more efficient way of baking and forming the pocket bread. The pocket breads can also be hand-held which makes consumption by a consumer easier too. Furthermore two cut lines arranged perpendicularly to one another can achieve four equally sized pocket breads, for example if the cut lines are across two perpendicular centrelines of the portion.

The method may further comprise cooling the bread before cutting the bread into at least two parts.

Cooling the bread portion before cutting can ensure a more robust bread in comparison with the same bread when warm or hot, which is less likely to be damaged when cut.

The method may further comprise packaging the pocket breads.

The pocket breads are packaged so that they can be stored and transported if required; packaging can also improve the shelf life and freshness of the bread for a consumer.

The sheet of dough can have a negligible or zero re-worked dough content and can be made entirely of virgin dough.

Re-worked dough can become tougher than the preferred soft dough, and leftover dough can be costly and inefficient. Virgin dough is dough which has not been re-worked.

After baking, each bread may be separate from an adjacent bread and all edges of each bread are evenly baked.

The bread portions shrinking and separating during the baking process can mean that the maximum number of portions can enter the oven having minimal or no separation distance between them. This improves the efficiency of the process without compromising on an even bake on all edges of the bread.

Each pocket bread may be substantially consistent in shape and size.

A consistency in shape and size can enable easier packaging, more consistency in weight and size for transport, and consistency in size so that each pocket bread contains the same amount of foodstuffs. Consistency in the shape and size of the bread can also allow for easier mass production.

According to a second aspect of the invention, there is provided an apparatus for cutting a bread comprising: a surface for supporting the bread, the surface comprising one or more apertures; a water jet cutter disposed on a first side of the bread, comprising a nozzle with an orifice size less than 2 mm in diameter to cut the bread; and a collection drain, disposed at a second side of the bread, opposite to the first side, to collect and divert water from the nozzle away from the bread after cutting, wherein the water jet cutter cuts the bread without damaging a cut edge of the bread, welding the cut edge of the bread, or leaving residual moisture on the cut edge of the bread.

Water jet cutting the bread can be advantageous over alternative methods as it provides a clean cut without welding the edges of the bread together, which can occur when using a guillotine to make the cut, or without damaging the edges of the bread, such as when a band saw is used to make the cut.

The surface can convey the bread at a speed of 1 to 8 m/minute, preferably 3 to 6 m/minute, and more preferably 3 to 4 m/minute which enables a clean cut to be obtained without leaving excess water on the bread.

A biasing means can act on the bread, such that the bread is biased towards the surface during cutting. The biasing means can be a suction means to hold the bread against the surface during cutting. A venturi fan can provide the suction means to hold the bread against the surface during cutting and the suction means can comprise a downward air movement typically of about 5000 Cubic Feet per Minute (2.36 m³/s) at 0.375 inch static pressure (93.4 Pa). However, it can be appreciated that other values would be suitable for biasing the bread against the surface. During water jet cutting the bread can move. Providing the biasing means, or supports on the surface can ensure minimal movement of the bread during cutting and therefore a more accurate cut can be made.

The surface can be disposed between the bread and the collection drain.

The nozzle of the water jet cutter can be located less than 30 mm from a surface of the bread, preferably less than 15 mm from a surface of the bread and more preferably less than 10 mm. The nozzle can be a minimum distance from the bread. However, as the surface of the bread may not be perfectly flat, larger nozzle distances are more commonly used.

This helps to minimise flaring of the water jet which could lead to excess water on the cut edge of the bread.

The bread can be a pocket bread such as a Pita.

Advantageously the cut does not seal the pocket of the Pita bread, allowing the cut edge to be open and the very soft bread is not damaged by the cut.

The water jet cutter can comprise nozzles which can be made of diamond or sapphire to reduce abrasion.

According to a third aspect of the invention there is provided a pocket bread having four edges, two of which are open providing access to a pocket within the pocket bread, wherein a user can easily fill the pocket bread with further foodstuffs, without the requirement of a secondary process to provide access to the pocket, wherein the pocket bread further comprises an outer surface and an inner surface, wherein the inner surface is softer than the outer surface.

The pocket bread can comprise at least one rounded corner between two closed edges.

A pocket bread open on two edges is easier to fill and can be hand-held. Reducing the need for a secondary opening process reduces the risk of damage or wastage of the pocket bread. Often during opening a user can tear the bread or damage the bread. Also the opening process can be inconsistent (for example a user using a knife to provide access to the pocket within the bread), and the opening provided is not suitable for optimally filling the pocket bread. A soft inner surface and a less soft outer surface mimics the popular and traditional Pita bread which requires opening by a secondary process. The less soft outer surface relative to the inner surface is more appetising to a consumer.

### BRIEF DESCRIPTION OF THE DRAWINGS

One or more embodiments of the invention will now be described, by way of example only, with reference to the accompanying drawings, in which:

FIG. 1 shows a known Pita bread which forms part of the state of the art;

FIG. 2 shows an isometric view of a pocket bread according to one embodiment of the invention, having four edges, two of which are open to provide access to the pocket within;

FIG. 3 shows a portion of bread from which the pocket bread of FIG. 2 can be cut;

FIG. 4 shows a number of alternatively shaped portions of bread from which a pocket bread according to one embodiment of the invention may be cut;

FIG. 5 shows a belt system for dusting two opposite sides of a sheet of dough with additional surface flour;

FIG. 6 shows a diagrammatic view of the baking apparatus including the tessellating portions of bread of FIG. 3; and

FIG. 7 shows a diagrammatic view of the cutting apparatus according to an embodiment of the invention;

FIG. 8 shows a sheet of dough which has been cut into substantially tessellating portions of bread according to a second embodiment;

FIG. 9 shows an isometric view of a pocket bread resulting from the tessellating portions of FIG. 8;

FIG. 10 shows an isometric view of an alternative pocket bread resulting from the tessellating portions of FIG. 8;

FIG. 11 shows a portion of bread from which the pocket bread of FIGS. 9 and 10 can be cut.

### DETAILED DESCRIPTION

The term pocket bread can refer to any flour and water based dough which is manufactured in such a manner to form a bread that comprises a space or pocket within. Examples of such bread can include Pita breads, soft taco shells and sandwich thins, however a large number of alternative bread items can fall within the definition of a pocket bread. Furthermore the flour referred to in this specification can be considered to be white, brown, rye, strong, almond flour, gluten free flour or any other product from which bread can be made in substitution of any of the flours previously recited.

The term proofing used throughout this specification can also be known as proving or blooming and means to allow the bread dough to rise. Any alternative term may also be used for the period of time in which dough is allowed to rest and grow in size.

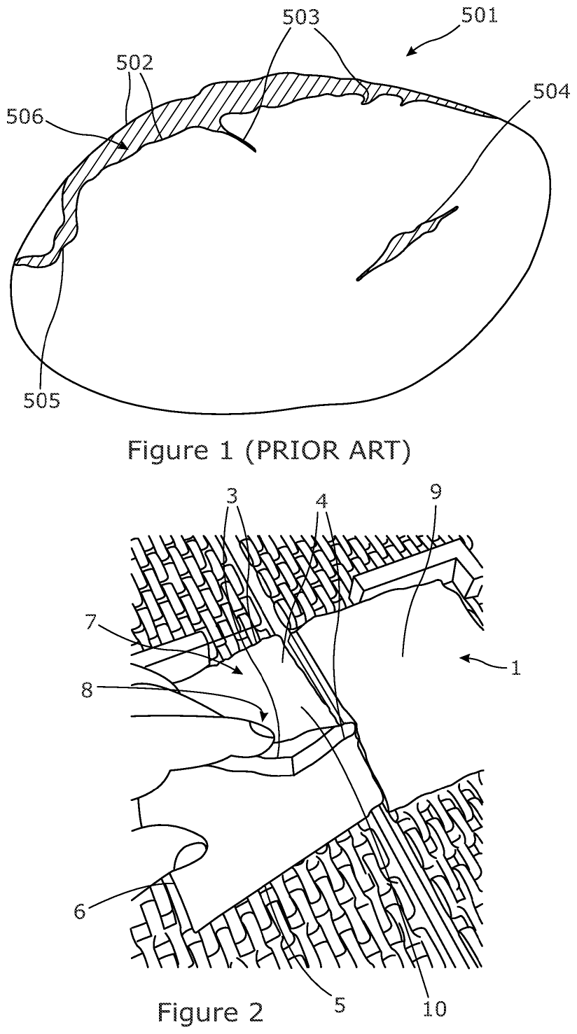

Referring now to the drawings, FIG. 1 shows a known Pita bread 501. The known Pita bread 501 is a pocket bread which is substantially round or oval in shape and requires a secondary process to form the opening 502 to access the pocket 506. The secondary process is usually a manual process performed by a user with a knife before filling the Pita with foodstuffs. This can cause tearing 503 or damage 504 to the Pita bread, which may lead to wastage of the product. Furthermore the openings can be inconsistent and often ineffective for easily filling the Pita, for example if the openings are too narrow or created in an undesirable position 505. Such known breads are not suitable for high volume food service industries (e.g. QSRs—“quick service restaurants”). This is due to some of the problems previously described and specifically that the opening, pocket forming and filling process can be time-consuming, inconsistent and inconvenient.

FIG. 2 shows a pocket bread 1 according to a first embodiment of the invention. The pocket bread 1 comprises four edges, a first open edge 3, a second open edge 4, a first closed edge 5 and a second closed edge 6. The open edges 3 and 4 form an access aperture 7 or opening to provide access to a pocket 8 in the pocket bread 1. The pocket bread 1 being open on two edges provides a quicker, easier and more efficient means to fill the pocket bread with foodstuffs, for example but not limited to, sandwich fillers, salad, meat or meat alternatives, all of which can be hot or cold fillings. It also provides a pocket bread 1 which is easily held in a consumer's hand whilst being eaten. The access aperture 7 is formed as part of the manufacturing process so that a secondary opening process is not required. For example, a user does not have to manually provide the opening 7 in the pocket bread 1 by cutting it with a knife. It is appreciated that alternative secondary opening methods are known, other than opening with a knife.

Although FIG. 2 illustrates a square pocket bread 1 being open on two edges 3, 4 it can be appreciated that the pocket breads can be a large number of different shapes, sizes and configurations. For example the pocket breads can be polygonal, preferably quadrilateral and more preferably rectangular or square. They could be quadrilateral with a rounded corner, or more than one rounded corner. They could be triangular, pentagonal or hexagonal. Alternatively they could be rounded or oval shaped.

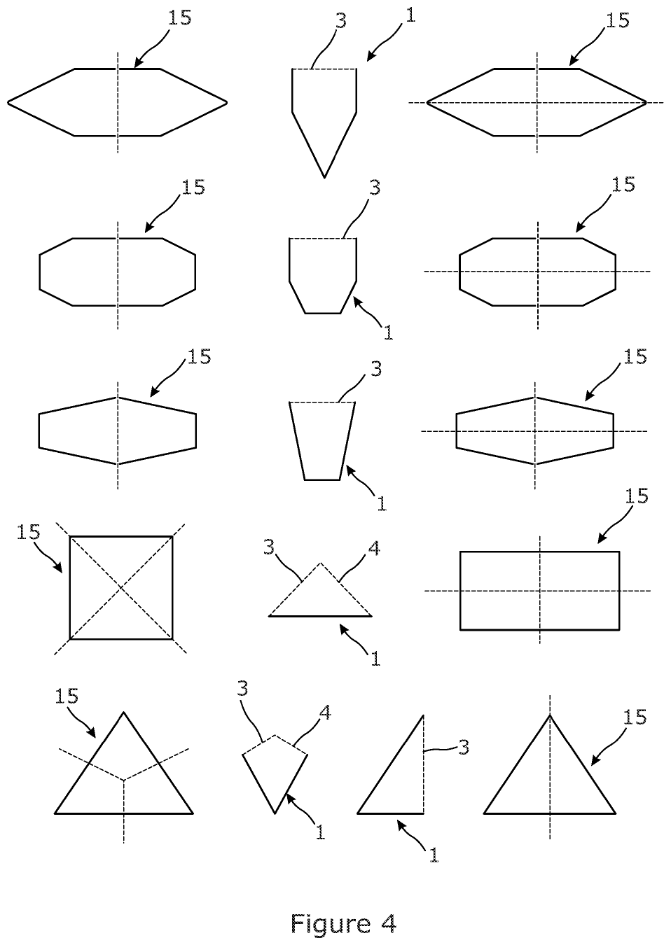

Furthermore the pocket bread 1 can be open on one edge, two edges, or more than two edges for filling the pocket with foodstuffs. Some alternatives are shown in FIG. 4, however it can be appreciated that there are a large number of alternative configurations other than those examples illustrated in FIG. 4. The pocket bread 1 comprises an outer surface 9 and an inner surface 10. The inner surface 10 is typically softer than the outer surface 9. The outer surface 9 is typically golden baked, whilst the inner surface 10 remains soft. The inner surface 10 is formed within the bread during baking, delimiting the pocket 8 as the pocket is formed.

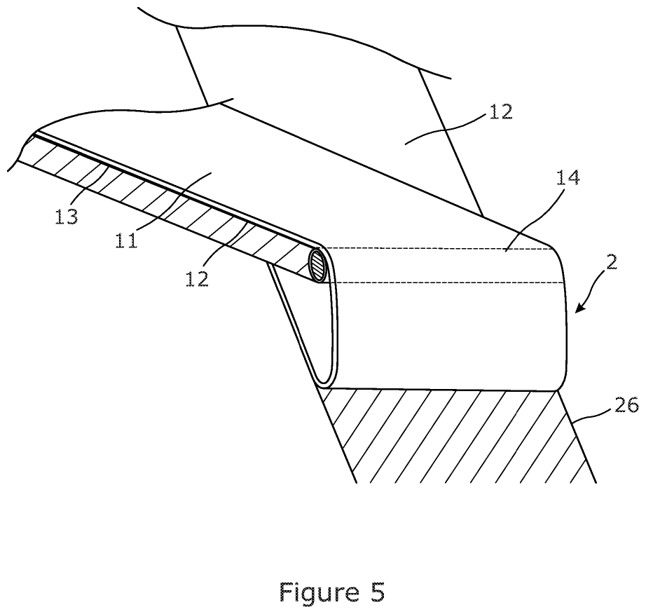

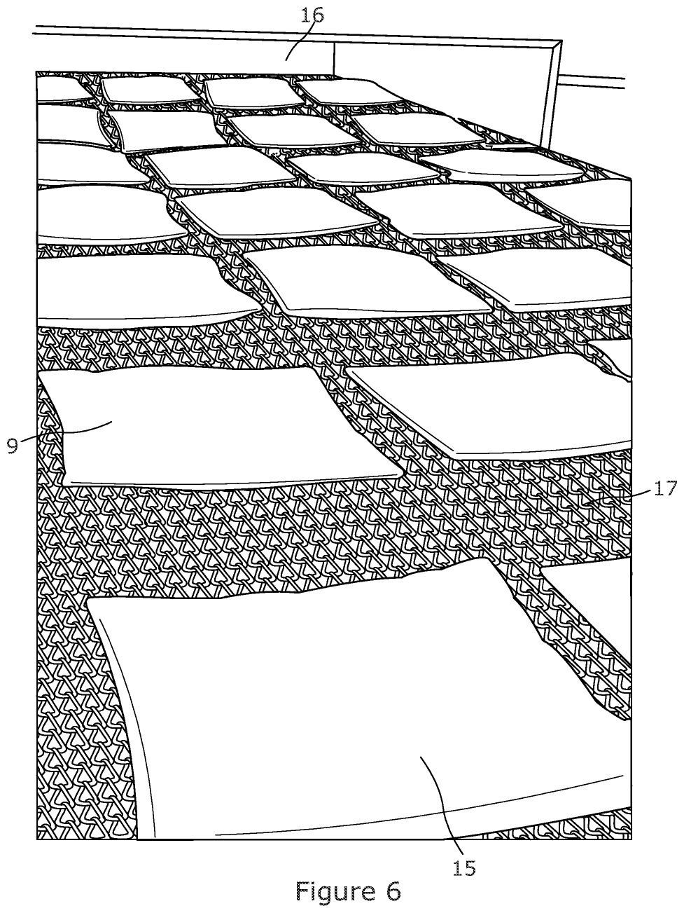

A pocket bread 1, such as that illustrated in FIG. 2, is made of soft dough, the manufacturing process for said pocket bread 1 is as follows. The ingredients to make the dough comprising flour and water are placed in a mixer to form and knead the dough. The dough is then placed onto a sheeter, to form the dough into a continuous sheet 2. Typically a belt of the sheeter is dusted with flour, the dough is added to the belt and the dough is then dusted with flour and rolled into a sheet. The flour dusting and rolling is then repeated, however the sheet of dough 2 is rotated through 900 as illustrated in FIG. 5. The sheet of dough 2 has a first surface 11 and a second surface 12, both the first surface 11 and the second surface 12 are dusted with additional flour. Initially the first surface 11 faces in an upward direction and the second surface 12 faces a downward direction. To rotate the sheet of dough such that the first surface 11 faces downwards and the second surface 12 faces upwards, a first belt 13 has an angled end 14, the sheet of dough travels over the angled end 14 and onto a second belt 26, the second surface 12 facing in an opposite direction to when it was on the first belt 13. The sheet of dough 2 is dusted with flour to reduce the risk of the dough sticking while continuing through the manufacturing process. The dough is then passed to a cross pinner which widens and destresses the dough, before being rolled by a first calendar roller to minimally reduce the thickness of the sheet of dough 2. A surface of the sheet of dough 2 is then further dusted with flour before being rolled by a second calendar roller to minimally reduce the thickness of the sheet of dough 2 further. This second reduction in thickness also calibrates the weight across the sheet of dough 2. As the sheet of dough 2 travels through the manufacturing process, due to the linear nature of the manufacturing process, gluten in the dough can begin to align. This can cause stress in the dough and can result in a tougher dough than desired. The handling of the dough throughout the manufacturing process is intended to be minimal, to mimic the handmade nature of a traditional pocket bread. If the calendar roller was used too much, the dough can become degassed and therefore stressed and tough. However, weight calibration across bread portions 15 (shown in FIG. 6) is important to get a consistent thickness of bread. The calendar rollers are used enough to obtain a good weight calibration, but as little as possible to avoid degassing of the dough. The sheet of dough 2 is prepared for travel to a multi belt proofer. It can be appreciated that the process described above can be re-ordered, comprise a different combination of the processes described above, or include further steps.

The multi belt proofer is a series of continuous belts arranged in tiers, over which the sheet of dough 2 passes while the sheet of dough 2 proofs in the proofing room. It has a tier selection capability for adjusting the resting period of an incoming sheet of dough 2 into the proofing room. The multi belt proofer also comprises a self-aligning belt mechanism to keep the tiered belts perfectly aligned to one another. Perfect alignment of the belts ensures the centreline of the sheet of dough 2 remains consistent throughout the transfer of the sheet of dough 2 through the proofing room.

The multi belt proofer is located in a room having specific conditions such as a controlled humidity, preferably between 60% to 90% relative humidity, preferably 60% to 80%, more preferably 60% to 75% and typically 70% relative humidity, and relative warmth of between 30° C. and 40° C. However, it can be appreciated that the leavening requirements will vary depending on the composition of the dough and the above is provided as an example only. The conditions of the proofing room can also vary depending on the ambient or climatic conditions outside the proofing room. For example if the dough is relatively colder than expected when entering the proofing room, the conditions of the proofing room are adjusted to suit. The high humidity allows additional flour remaining on the surface of the dough 11, 12 to absorb moisture from the room. This ensures that the additional flour does not act as a barrier during baking. If the flour acts as a barrier during baking, then the resulting bread will have a dull coloured bake as opposed to a golden brown coloured bake. The golden brown is more appetising for a consumer when eating the pocket bread 1. The humidity and warmth of the proofing room also enables the dough to proof, yeast to act and gluten to relax. After proofing, typically for 20 to 40 minutes, and when the additional flour is sufficiently moistened the dough is ready to be cut and baked. A visual indication of when the additional flour is sufficiently moistened is when the flour can no longer be noticed by a human eye on the surface 11, 12 of the dough. Another indicator of when the dough is ready to leave the proofing room can be when it has risen by at least 50% or up to 100%. The rise depends on the quality of the flour used to make the dough, for example if a high quality flour is used, such as strong Canadian flour, then the protein structure is such that the dough is more resilient and can support a higher lift. It can be appreciated that the proofing times may also vary depending on the specific ingredients in the dough, the activity of the yeast, the ambient process conditions outside the proofing room, and the proofing room conditions.

Once proofed, the sheet of dough 2, which can be considered a continuous sheet of dough, is cut into portions 15, typically by circular slitting blades and transverse cutters, however alternative cutting methods can be used. The cutters can include a crimping action on the edge of each cut depending on the flour and dough quality. A crimped edge is more robust, and is therefore advantageous when filling the pocket within the bread. The risk of damage or tearing to the edges of the bread when filling are reduced due to the crimped edge. They may also include a continuous clearing means, usually by means of a brush, to prevent build-up of excess flour and dough on the cutters. This is particularly important where the cutter includes a crimping action. Varying the speed of the transverse cutters can influence the length of the portion 15 cut from the continuous sheet of dough 2.

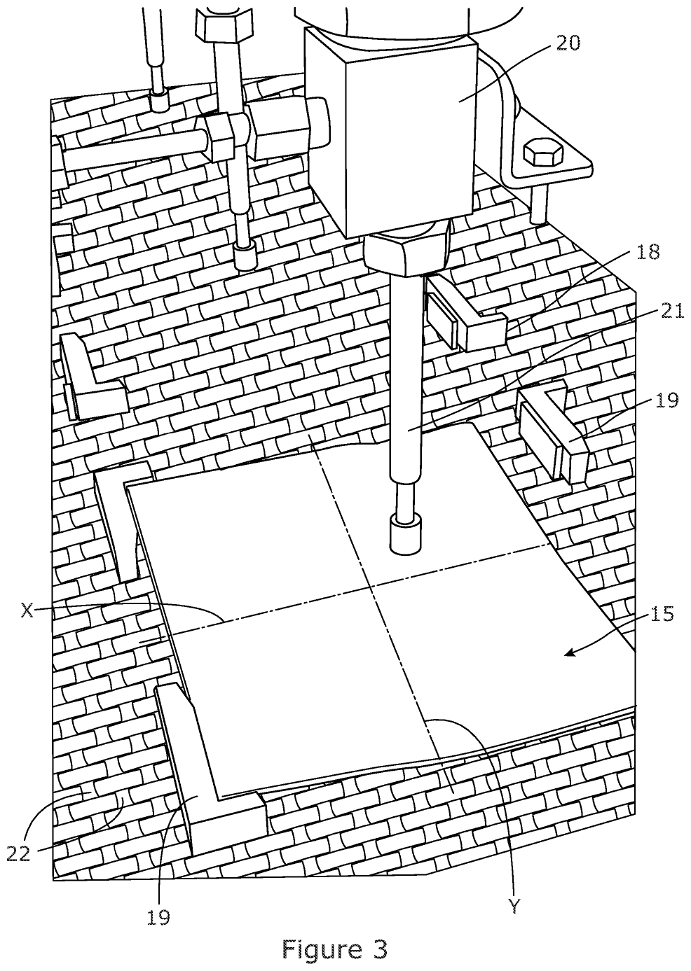

One such example of a portion 15 cut from the sheet of dough is illustrated in FIG. 3 in which the bread portion is square shaped. The bread portion 15 is polygonal in shape, preferably a quadrilateral shape and more preferably a square or rectangular shape, as shown in FIG. 3. The bread portion 15 is shaped so that it can be efficiently cut from a sheet of dough 2, forming shapes which substantially tessellate with one another ensuring minimal leftover dough or dough to be reworked, and in the case of the embodiment shown in FIG. 3, no dough to be reworked at all.

Where the term ‘tessellate’ is used herein, it means that the portions 15 are arranged close to each other such that there is minimal leftover dough. For example where a series of portions 15 are said to substantially tessellate they are arranged on the sheet of dough 2 such that a small proportion of the sheet of dough 2 needs to be reworked. In some embodiments a portion 15 is in contact with at least one other portion 15. In some embodiments comprising tessellating shaped portions 15 the amount of re-worked or wasted dough is less than 20%. In other embodiments there is less than 10% re-worked dough and in other embodiments there is less than 5% re-worked dough. Alternatively in some embodiments, as shown in FIG. 3, there is no re-worked or wasted dough. Shapes which tessellate best, having the minimal amount of unused dough when cut from the sheet 2 are triangles, quadrilaterals and hexagons, as shown in FIG. 4. However, alternative shapes or combinations of shapes can be envisaged, including those with rounded edges.

Prior to baking, the portions 15 can undergo an additional process, such as steaming, or glazing or an alternative process to enhance the appearance or taste of the final bread.

The portions 15 are conveyed to the oven 16 for baking on a belt 17 as illustrated in FIG. 6. The portions 15 are arranged largely in rows with a minimal separation between each portion 15 to maximise the utilisation of the oven, improving the overall efficiency of the manufacturing process. The portions 15 are baked typically at 350° C. to 390° C. for 75 to 90 seconds. However, it can be appreciated that these temperatures and timings will vary depending on the ingredients of the dough and the desired bake. The portions 15 are baked into bread such that steam is generated from the dough during baking, such that a pocket 8 is formed inside the bread. The portions 15 are baked at a temperature in which a pocket 8 can be formed, but also that any excess steam generated in the pocket 8 can be released without damage or significant rupture to the pocket bread. During baking and as the pockets 8 are formed, the portions 15 lift away from the belt 17, each bread shrinking away from an adjacent bread during baking, such that the separation distance between each bread or portion 15 is increased. The increased separation enables no edges of the bread or portions 15 to remain in contact which provides an even bake on all edges, leaving no part of the portion 15 under baked. This also enables an increased throughput through the oven as more portions can be baked at any time. The oven 16 bakes the bread, forming a golden baked outer surface 9 and softer inner surface 10 delimiting the pocket 8. The process and gentle baking method results in a pocket bread that has a reduced risk of steam rupture, typical of known high intensity Pita baking processes.

After baking the portions 15 can be cooled. Each portion 15 is then placed in a precise position on a surface 18 ready for cutting. This placing method can be carried out by hand, or by robotics, specifically it could be carried out by pick and place robots to accurately pick the portion 15 from the belt and place the portion 15 on the surface 18. Pick and place robotics, or an alternative, can also be used to remove the pocket breads 1 from the surface 18 after they have been cut. The surface 18 may include supports 19 for each portion 15 to abut to ensure the accurate location of each portion 15 for cutting. The baked portion 15 illustrated in FIG. 3 is cut across a first centreline X and a second centreline Y to form the pocket bread illustrated in FIG. 2. However it can be appreciated that the bread may comprise only one cut, and the resulting pocket bread may only be open on one edge, or on more than two edges. The pick and place robotics, or an alternative, can also be used to re-orientate the portions 15 between cuts, i.e. in this example after centreline X has been cut the portions can be rotated through about 90° such that centreline Y can be cut. Further examples of portions and the resulting pocket breads can be seen in FIG. 4 and FIGS. 9 to 11.

Re-worked dough can become tougher than the preferred soft dough. A large separation distance between breads or portions 15 can be inefficient and costly as less bread can be baked in a specific time period. If the separation distance is too small the edges of the breads or portions 15 will not bake evenly. A dull bake can also be off-putting for a consumer who would expect bread baked with a golden brown colour.

Often when using known methods a secondary opening process is required when a user comes to fill the pocket bread 1. Often during opening a user can tear the pocket bread 1 or damage the pocket bread 1. Also as the opening process can be inconsistent (for example a user using a knife to provide access to the pocket within the pocket bread), the opening provided is not suitable for optimally filling the pocket bread 1.

The portions are cut by a water jet cutter 20, however it is appreciated that alternative cutting means could be used. Cutting the portions with the water jet cutter 20 can be advantageous over alternative methods as it provides a clean cut without welding the edges of the pocket bread 1 together, which can occur when using a guillotine to make the cut, or without damaging the edges of the bread, such as when a band saw is used to make the cut. Water jet cutting also allows soft bread to be cut which other methods, if used, would damage the bread. The quantity of water used for the cut is minimal. The quantity of water in contact with the cut edge is minimal because it is delivered in a focused non-flaring jet, through a narrow nozzle. This is mainly due to the small size of the nozzle 21, which is less than 2 mm in diameter, preferably less than 1 mm in diameter and typically the nozzle is about 0.2 mm in diameter. The nozzle 21 is made of diamond or sapphire to improve the abrasion resistance, however it can be envisaged that the nozzles 21 are made of an alternative suitable material.

The water jet cutter 20 also acts at a high pressure, typically between 45,000 psi and 55,000 psi when applied across three nozzles 21. It can be appreciated that the pressure will vary depending on the nozzle size, which can vary, and the number of nozzles 21. Due to a small diameter nozzle 21 and a relatively high pressure, water from the nozzle 21 travels in a largely parallel path with minimal flaring as it exists the nozzle 21. This can be further improved by the nozzle 21 being located very close to the portion 15 or pocket bread 1 during cutting. Preferably the nozzle 21 is located less than 30 mm from the surface of the bread, preferably less than 15 mm from a surface of the bread, or less than 10 mm. This combined with the minimal quantity of water used means that any water that remains on the bread (pocket bread 1 or portion 15) after cutting is easily reabsorbed by the bread or dried by evaporation with minimal impact on the overall quality of the pocket bread 1.

The surface 18 can convey the portions 15 at a speed of 1 to 8 m/minute, typically 3 to 6 m/minute and preferably 3 to 4 m/minute to obtain a clean cut without leaving excess water on the resulting pocket bread 1. However, it can be appreciated that the speed at which the portions 15 are conveyed can be optimised with the size of the nozzles 21, such that a cut is obtained with minimal dwell time during cutting. This reduces water contamination of the cut edge. Therefore alternative speeds can be envisaged. Preferably the water used to cut the bread in the water jet cutter 20 has been softened in order to keep the nozzles 21 clear.

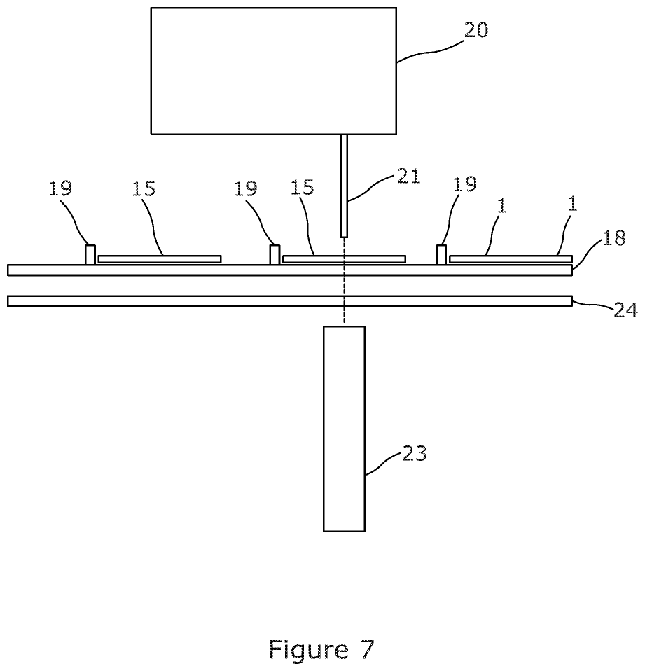

As illustrated in FIG. 7, the surface 18 comprises a plurality of apertures 22 (shown in FIG. 3) so that water from the water jet cutter 20 can pass through the surface 18. This ensures minimal water remains on the surface 18 after the bread has been cut which could further wet the bread. The apertures 22 also provide communication from the water jet cutter 20 to a collection drain 23 located on the opposite side of the surface to the bread. The collection drain 23 can be in the form of a gutter, tubes, funnel, or alternative drainage means to further reduce the risk of wetting the cut bread from splashback, mist or residual water left on the surface 18. The collection drain 23 can include suction means to encourage any excess water from the water jet to be drawn away from the bread. It can be appreciated that the water jet cutter 20 further includes both a collection drain 23 and a further suction or blowing means located above the bread (not shown), at the opposite side of the bread to the collection drain 23, to further encourage excess water from the water jet cutter 20 to be drawn away from the bread. Each nozzle 21 may have an associated collection drain 23, or there may be a large communal collection drain 23 to service all nozzles 21. The water may be collected and re-used in the water jet cutter 20.

The water jet cutter 20 further comprises a biasing means 24 to hold each bread biased against the surface during cutting. Water jet cutting can sometimes cause the bread to move if not held in place. This can be achieved by any known mechanical biasing means, however in the present example it is achieved by a suction means 24 underneath the surface 18, at the opposite side of the surface 18 to the bread. The suction means 24 can be generated by a venturi fan throughout the length of the surface 18 or specifically located underneath each support 19, or set of supports 19. The surface 18 acts as a belt and conveys the bread through the cutting process. Typically the venturi fans achieve a downward air movement of about 5000 Cubic Feet per Minute (CFM) (2.36 m³/s) at 0.375 inch static pressure (93.4 Pa).

A second embodiment is illustrated in FIGS. 8 to 11 and comprises a number of the same features of the previously described embodiment, like features retain the same reference numerals. A difference with the second embodiment is that a corner 26 of the pocket bread 1 has been rounded. The corner 26 is rounded such that the pocket bread 1 can be filled more easily and conveniently.

As illustrated in FIG. 8, the portion 15 is cut from the sheet of dough 2 in a tessellating pattern such that minimal dough is needed to be reworked. The sheet of dough 2 comprises pattern cut lines 27, dough for re-work or disposal 28 and the portions 15. In some embodiments at least one edge of the portion 15 is in contact with another portion 15 when cut from the sheet of dough 2.

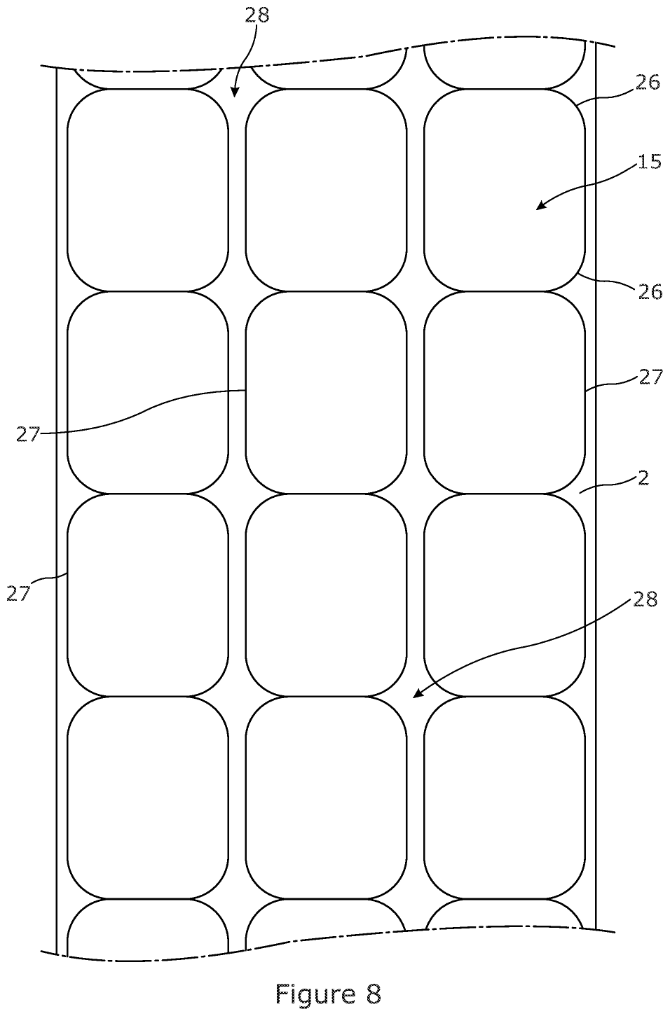

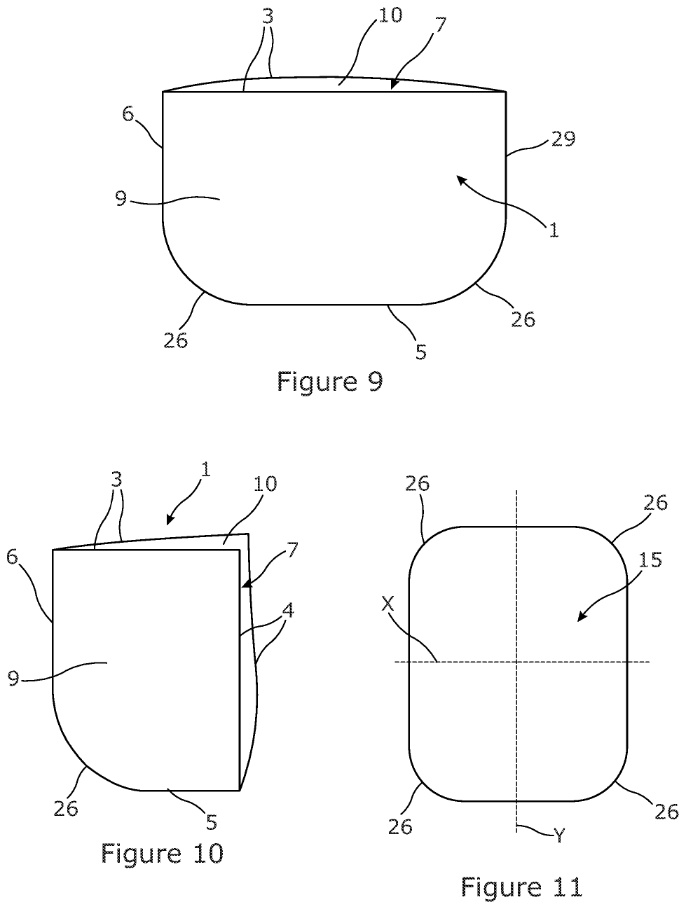

As illustrated in FIG. 9, the portion 15 of FIGS. 8 and 11 can be cut to form a pocket bread 1. The pocket bread 1 comprises a first open edge 3, a first closed edge 5, a second closed edge 6 and a third closed edge 29. The first closed edge 5 and second closed edge 6 are separated by the rounded corner 26, and the first closed edge 5 and third closed edge 29 are separated by a further rounded corner 26. The open edge 3 forms an access aperture 7 or opening to provide access to a pocket 8 (not shown) in the pocket bread 1.

As illustrated in FIG. 10, the portion 15 of FIGS. 8 and 11 can be cut to form an alternative pocket bread 1. The pocket bread 1 comprises a first open edge 3, a second open edge 4, a first closed edge 5 and a second closed edge 6. The first closed edge 5 and second closed edge 6 are separated by the rounded corner 26. The open edges 3 and 4 form an access aperture 7 or opening to provide access to a pocket 8 (not shown) in the pocket bread 1.

FIG. 11 illustrates the portion 15 comprising cut lines X and Y, from which the pocket bread 1 of FIGS. 9 and 10 can be made. The portion 15 comprises the rounded corner 26.

It can be envisaged that more or less dough re-work is required than what is shown in the Figures. For example, in one embodiment the tessellating portions 15 are in contact with an adjacent portion 15 on two edges when cut from the sheet of dough 2. In other embodiments the tessellating portions can be in contact with an adjacent portion on more than two edges. In some embodiments the portions 15 do not contact an adjacent portion but there is a minimal amount of dough between them.

In some embodiments the surface 18 can be made of a plastic, metal or alloy of any material which is suitable for the manufacture of food products. Furthermore all the apparatus in this specification should be suitable for food production and can be modular or integrated.

The breads described in this application are preferably made from soft dough having a higher water content than a tougher dough. Soft dough can have a moisture content of 50% or above, preferably between 55% to 75% of flour weight. For a Pita bread, as an example, the dough preferably has a moisture content of 60% to 70% of flour weight. Higher protein flour and colder doughs can typically carry more water. However, the product, process and apparatus described herein can be used with any type of dough. Furthermore the cutting apparatus described herein can be used to cut any item which is baked, for example but not limited to cakes, biscuits, pastry or bread. The term bread can mean the pocket bread 1 or the portion 15 after it has been baked. Once cut, the baked portion 15 becomes the pocket bread 1.

In order to address various issues and advance the art, the entirety of this disclosure shows by way of illustration various embodiments in which the claimed invention(s) may be practiced and provide for a superior apparatus. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the disclosure. Various embodiments may suitably comprise, consist of, or consist essentially of, various combinations of the disclosed elements, components, features, parts, steps, means, etc.

1. A method of manufacture of a bread, the bread comprising a pocket and having at least one open edge, the method comprising:
preparing a dough comprising flour and water;
working the dough into a sheet including dusting a surface of the sheet of dough with additional flour;
proofing the sheet of dough in a proofing room having a pre-determined humidity level, such that a moisture content of the additional surface flour is increased;
cutting the proofed sheet of dough into a plurality of substantially tessellating shaped portions;
baking each portion to form a bread, such that steam is generated during baking and forms a pocket in the bread,
each bread shrinking away from an adjacent bread during baking, such that the separation distance between each bread is increased; and
cutting each bread into at least two parts, each part forming a pocket bread having at least one open edge, the open edge providing access to the pocket, wherein a secondary opening process is not required to provide access to the pocket.

2. A method according to claim 1, wherein each bread is cut into at least two parts by a water jet cutter.

3. A method according to claim 1, wherein the sheet of dough comprises a first side and a second side, the first side disposed opposite to the second side, wherein both the first side and second side are dusted with additional surface flour.

4. A method according to claim 3, wherein the sheet of dough is conveyed along a first belt where additional surface flour is added to the first side, the sheet of dough is then inverted onto a second belt where additional surface flour is added to the second side.

5. A method according to claim 4, wherein the end of the first belt, at the interface between the first belt and the second belt, is angled in respect to a direction of movement of the sheet of dough to assist in inverting the sheet of dough as it is conveyed from the first belt to the second belt.

6. A method according to claim 1, wherein the sheet of dough is conveyed as a continuous sheet.

7. A method according to claim 1, wherein the pre-determined humidity level, such that a moisture content of the additional surface flour is increased, is a relative humidity between 60% and 80%.

8. A method according to claim 1, wherein the pre-determined humidity level, such that a moisture content of the additional surface flour is increased, is a relative humidity of about 70%.

9. A method according to claim 1, wherein the tessellating shaped portions are at least one of polygonal in shape, or quadrilateral in shape.

10. A method according to claim 1, wherein the tessellating shaped portions comprise at least one rounded corner.

11. A method according to claim 1, wherein a first cut line is made across a first orientation of the bread, and a second cut line is made across a second orientation of the bread, the first cut line of the bread being substantially perpendicular to the second cut line such that four pocket breads each having two open edges are formed from the bread.

12. A method according to claim 1, further comprising cooling the bread before cutting the bread into at least two parts.

13. (canceled)

14. A method according to claim 1, wherein the sheet of dough has a negligible or zero re-worked dough content.

15. A method according to claim 1, wherein after baking each bread is separate from an adjacent bread and all edges of each bread are evenly baked.

16. A method according to claim 1, wherein each bread is substantially consistent in shape and size.

17. An apparatus for cutting a bread such as a pocket bread comprising:
a surface for supporting the bread, the surface comprising one or more apertures;
a water jet cutter disposed on a first side of the bread, comprising a nozzle with an orifice size less than 2 mm in diameter to cut the bread; and
a collection drain, disposed at a second side of the bread, opposite to the first side, to collect and divert water from the nozzle away from the bread after cutting,
wherein the water jet cutter cuts the bread without damaging a cut edge of the bread, welding the cut edge of the bread, or leaving residual moisture on the cut edge of the bread.

18. An apparatus according to claim 17, further comprising a biasing means to act on the bread, such that the bread is biased towards the surface during cutting, wherein the biasing means is a suction means to hold the bread against the surface during cutting.

19. (canceled)

20. An apparatus according to claim 18, wherein the suction means comprises a downward air movement of about 5000 Cubic Feet per Minute (2.36 m³/s) at 0.375 inch static pressure (93.4 Pa).

21. An apparatus according to claim 17, wherein the surface conveys the bread at a speed of 1 to 8 m/minute, preferably 3 to 6 m/minute and more preferably 3 to 4 m/minute, to obtain a clean cut without leaving excess water on the bread.

22. An apparatus according to claim 17, wherein the surface is disposed between the bread and the collection drain.

23. An apparatus according to claim 17, wherein the nozzle is located less than 30 mm from the surface of the bread.

24-25. (canceled)
